(19) United States
(12) Patent Application Publication
(10) Pub. No.: US 2007/0185598 A1
(43) Pub. Date: Aug. 9, 2007

(54) Cargo reservation system and method

(76) Inventor: Francisco Enrique Ortega, Weston, FL (US)

Correspondence Address: LERNER GREENBERG STEMER LLP, P O BOX 2480, HOLLYWOOD, FL, 33022-2480, US

(21) Appl. No.: 11/656,846

(22) Filed: Jan. 23, 2007

Related U.S. Application Data
(63) Continuation of application No. 60/761,117, filed on Jan. 23, 2006.

(51) Int. Cl. G06F 17/00

(52) U.S. Cl. 700/90

(57) ABSTRACT

A cargo reservation system and method is provided wherein interested parties are united together in the form of a club to purchase cargo transportation units or rights in a cargo space. The level of membership is based on the amount of cargo transportation units an interested individual has purchased in the club. A member is given the opportunity to reserve their total amount of cargo transportation units on a first come first serve basis without individual club members having to negotiate or bid on the price of the freight services.

### CROSS-REFERENCE TO RELATED APPLICATION

The present application claims priority from co-pending provisional patent application Ser. No. 60/761,117, filed on Jan. 23, 2006, and CARGO RESERVATION SYSTEM AND METHOD, that application being incorporated herein, by reference, in its entirety.

### BACKGROUND OF THE INVENTION

1. Field of the Invention

The invention relates to reservation system and method, and more particularly to a reservation system and method for scheduling cargo, freight or the like.

2. Description of the Related Art

Presently, due to the high operational cost of transportation, the cargo business is becoming increasingly expensive and complicated. Consequently, small, medium and even large carriers, cargo agencies, freight forwarders, manufacturers, service providers, couriers and others, face serious economic difficulties trying to find fair prices to transport their products.

Each country imports and exports its own particular products. At present, producers, importers/exporters and carriers ship their products with the different (few) airlines that operate in their countries. Due to this fact, prices vary from one day to the other according to sometimes unreasonable market fluctuations, which makes it almost impossible to make plan financially for medium and long terms.

Certain systems have been proposed wherein individual charterers or shippers bid for cargo space from individual transporters using a network, usually maintained by computer.

U.S. Pat. No. 6,436,419 to Kluss discloses an internet system for exchanging and organizing vessel transport information. In the '419 patent, a ship chartering system is implemented on a computer or telecommunications network, such as the internet, and is intended to supplement or replace services offered by current shipping brokers. The system of the '419 patent allows a charterer to locate acceptable ships, receive bids from ship owners and negotiate contract terms for their cargo. Ship owners in the '419 patent are able to update their ship positions and cargo capabilities, add new ships to a database of available ships, and bid on the transportation of cargo entered by a charterer. In the system of the '419 patent, both charterers and ship owners must subscribe to the system in order to access and participate in it.

United States Patent Application Publication No. 2002/0111892 A1 to Sharp et al., discloses a freight transportation marketplace, using a user interface with various levels of integration, that acts as an intermediary between buyers and sellers of freight transportation and provided the related support services. The marketplace of the '892 publication facilitates sales of freight transportation services, including multi-leg and multi-modal freight transportation services, through several systems including, catalog rates and auctions. The system of the '892 application allows buyers and sellers to enroll in the marketplace, maintain their accounts, and track their operation within the marketplace. It is alleged that the marketplace of the '892 application permits sellers to manage the rates they charge for providing freight transportation.

United States Patent Application Publication No. 2004/0220821 A1 to Ericsson et al., discloses a bidding method for time-sensitive offerings. In one embodiment of the invention of the '821 publication, the item to be auctioned comprises a vendor's time-dependent commitment to provide a service, such as freight services, personal services and rental services.

What is needed is a system and method to unite individual interested parties under strict parameters, in order to join efforts and be able to reach a bargaining capacity in cargo kilograms, pounds or other units, in order to substantially reduce the costs of transportation for the group. What is additionally needed is a system and method to rationalize and reduce, as much as possible, the operational costs of transportation, plus all the other services related with it. What is further needed is a system and method that eliminates all intermediaries and eradicates unnecessary expenses that increase the final costs of operation.

### SUMMARY OF THE INVENTION

It is accordingly an object of the invention to provide a cargo reservation system and method wherein interested parties are united together in the form of a club to purchase cargo transportation units or rights (“CTR” or “CTU”) or “packs” in a cargo space. The level of membership is based on the amount of cargo transportation units an interested individual has purchased in the club. In one particular embodiment, a member is given the opportunity to reserve their total amount of cargo transportation units on a first come first serve basis without individual club members having to negotiate or bid on the price of the freight services.

Other features which are considered as characteristic for the invention are set forth in the appended claims.

Although the invention is illustrated and described herein as embodied in a Cargo Reservation System And Method, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWINGS

FIG. 1 is a representation of a reservation screen for an airplane including a cargo compartment allocated into separate cargo transport rights, packs or units, in accordance with one embodiment of the present invention.

FIG. 2 is a representation of a reservation screen for a truck including a cargo carrying container portion allocated into separate cargo transport rights, packs or units, in accordance with one embodiment of the present invention.

FIG. 3 is a representation of a reservation screen for a ship including a cargo compartment allocated into separate cargo transport rights, packs or units, in accordance with one embodiment of the present invention.

FIG. 4 is a representation of a reservation screen for a train including a cargo carrying container portion allocated into separate cargo transport rights, packs or units, in accordance with one embodiment of the present invention.

FIG. 5 is a diagrammatic representation of one particular embodiment of the cargo reservation system of the present invention, including a world-wide computer network for arranging the transportation of cargo.

FIG. 6 is a flow diagram of one particular embodiment of a method of using a cargo reservation system of the present invention.

FIG. 7 is a flow diagram of a method of forming a club and allocating cargo transport rights, in accordance with one embodiment of the present invention.

FIG. 8 is an organizational chart for one particular embodiment of an organization that can be used with a cargo reservation system of the present invention.

### DESCRIPTION OF THE PREFERRED EMBODIMENTS

The present invention provides a cargo reservation system and method wherein interested parties are united together in an association to purchase “packs”, units or rights in a cargo space. In one embodiment of the present invention, the level of membership, and correspondingly the monthly maintenance fee paid, is based on the amount of cargo transportation units “subscribed to” or owned by an individual. A member is given the opportunity to reserve their total amount of cargo transportation units on a first come first serve basis, without individual club members having to negotiate or bid on the price of the freight services with individual carriers.

Although the following embodiments describe the use of a “Club” or “The Club”, it is understood that such term is not meant to be limiting, as other forms of associations, such as unions, cooperatives, partnerships, corporations, associations, etc., may be formed by a conglomeration of members, and still be within the scope of the instant invention. However, for purposes of simplicity, any association formed as described in the below described embodiments shall be referred to as a “club”. Further, note that, although the below embodiments describe the transportation of “cargo”, it is understood that the term references anything that can be transported in the cargo space of a vehicle, such as packages, courier items, air mail, materials, etc.

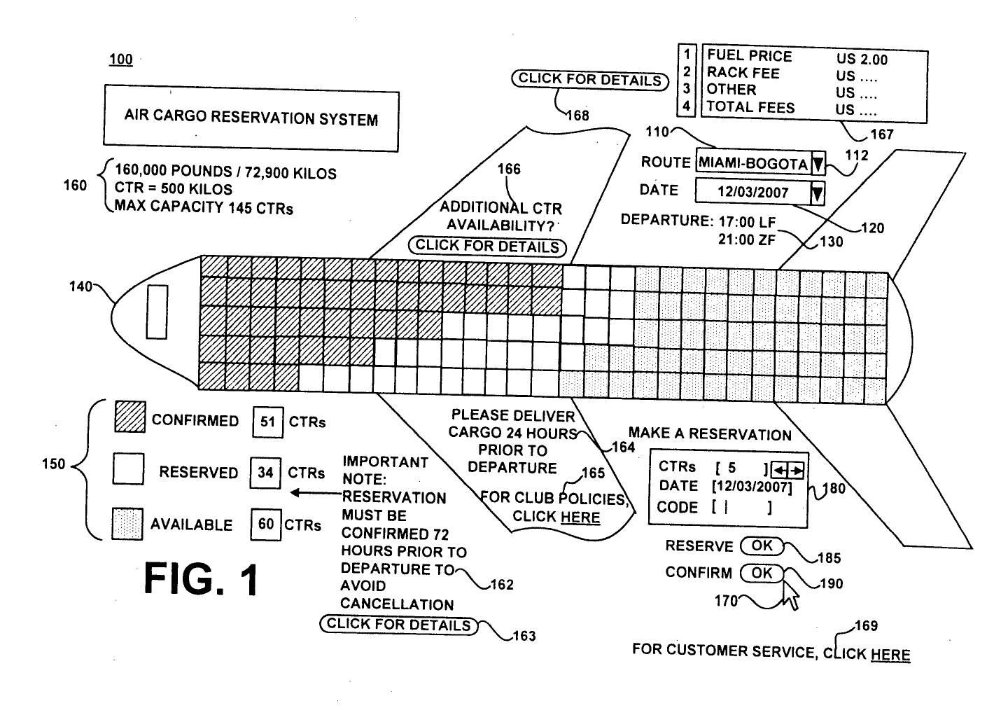

The invention will be described with reference to the exemplary embodiments shown in FIGS. 1-4. Note that those figures show certain examples, which are not meant to be limiting. For example, other types of transportation modes may be available, and the available space shown in those figures may be lesser or greater than shown, and the cargo transportation rights (CTRs), units (CTUs) or packs, etc., described, may be larger or smaller in size, and/or greater or fewer in number.

Referring now to FIGS. 1-4, there are shown four particular examples of how four different modes of cargo transport could be broken up in accordance with the present invention.

According to the targeted market, the founders, organizers and/or management association of the club chooses the most productive and advisable route (the one that moves the higher amount of cargo, for example, in kilograms) for the requested country or city. For instance, in the example of FIG. 1, research could have shown that air transport would be the most desirable means to service a route from Miami to Bogota. As such, in the example of FIG. 1, a plane or planes, may be rented, chartered or purchased by the organizers of the club and used for the purposes of that club and route. A second club may be formed that makes use of the plane on the route from Bogota to Miami, and thus, the two clubs may share the use and costs of the plane on its trips from Miami to Bogota and back to Miami.

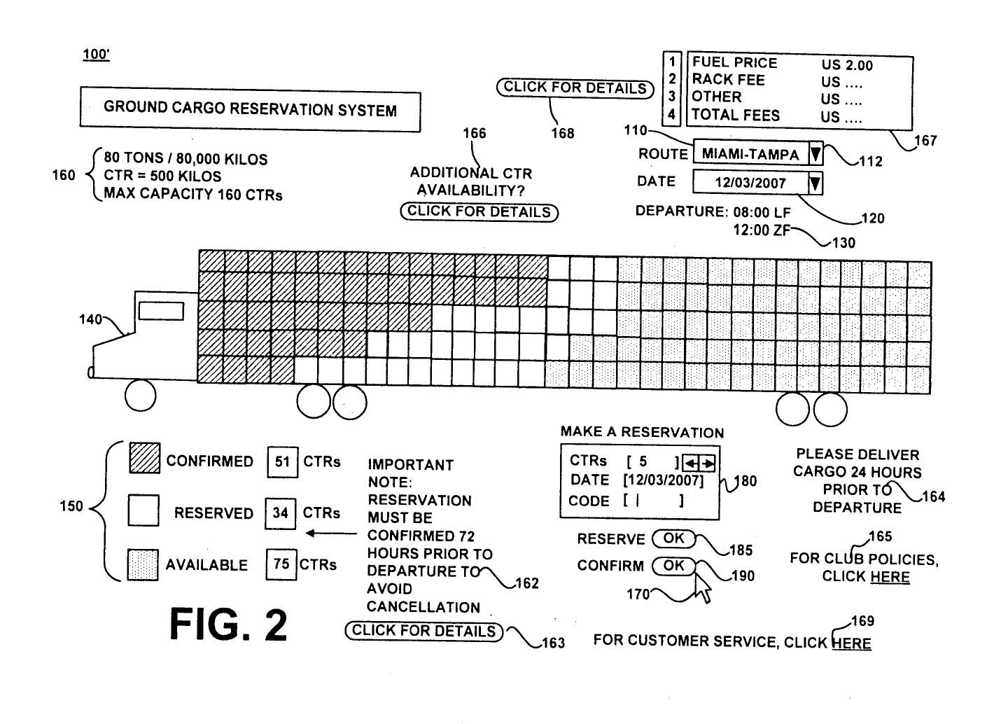

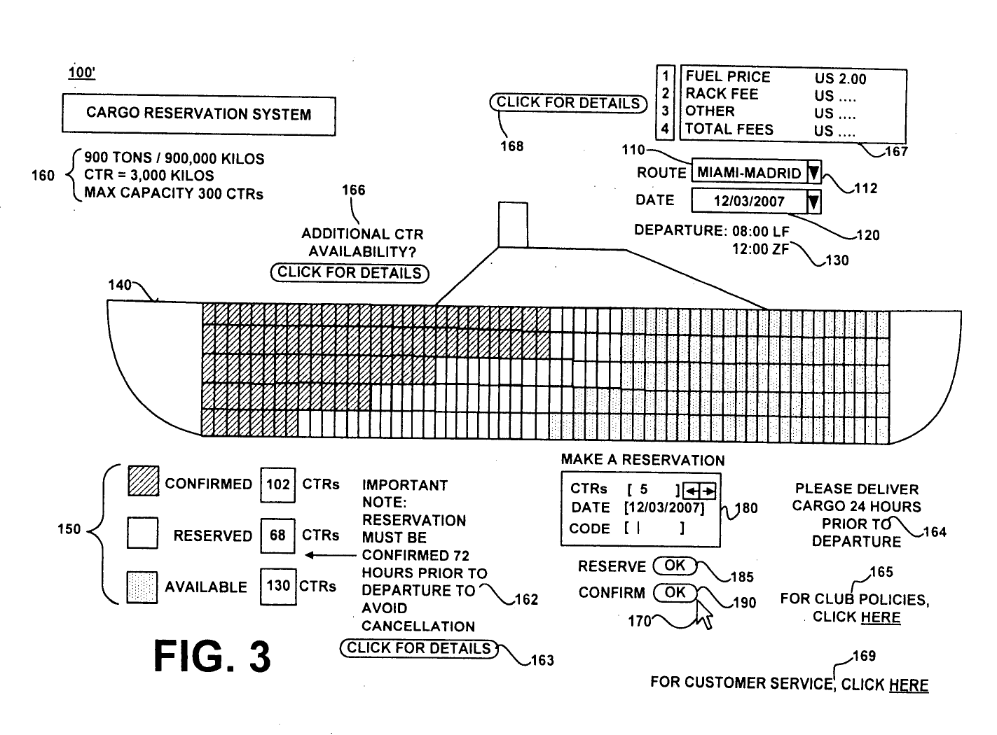

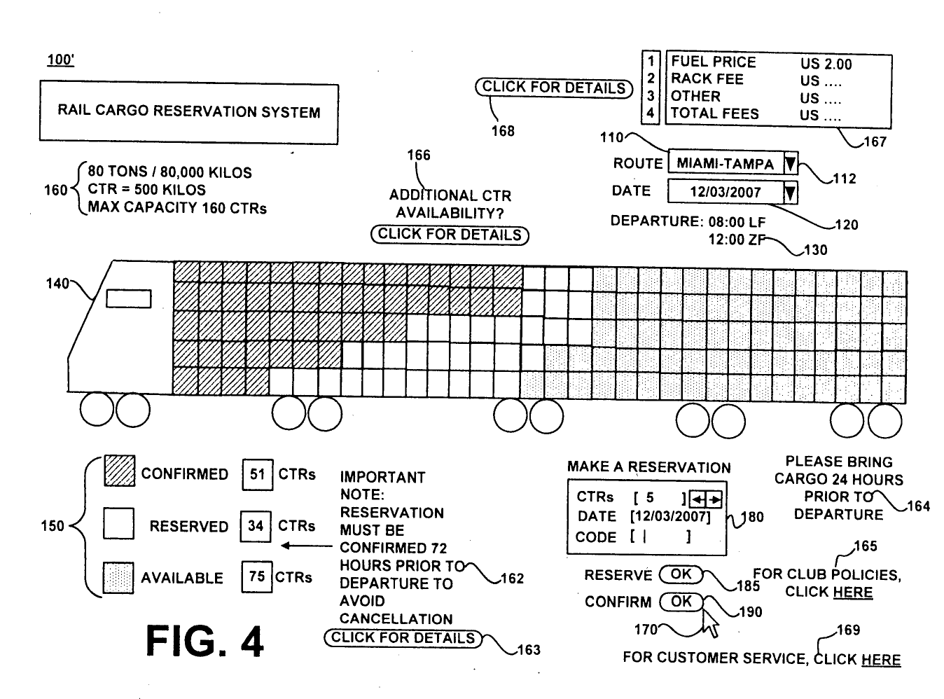

In the example of FIGS. 2 and 4, research may show that a truck (FIG. 2) or train (FIG. 4) may be the best mode of transporting cargo between Tampa and Miami, and a club for that route, utilizing container cargo space, may additionally be formed. Similarly, in the example of FIG. 3, research may show that transatlantic shipping may be the best route between Miami and Spain, and a club utilizing ships cargo may be formed just for that route. Another, different, club could be formed to utilize the ship's cargo hold for the return route from Spain to Miami. As can be seen, the organizers of the club, and not the members, would be responsible for predicting the market for the route and obtaining the necessary amount of transportation space in the desired mode of transport, for each route.

The organizers (and/or founders and/or management association) would then assess the space available for each route on the secured mode of transportation and break that total space into salable units, rights or packs, also referred to herein, interchangeably, as a “pack”, a cargo transport unit (“CTU”) or a cargo transport right (“CTR”). Each unit/pack/CTR represents a unit of space available to a member, for a time period, in the cargo transport area of the club's secured mode of transportation. For example, CTRs may be sold/assigned on the basis of a reoccuring time period such as weekly, monthly, quarterly, yearly, or based on some other, predefined, time period. Although CTRs can be sold for any time period defined by the club, by convention used herein for the purposes of explanation, CTRs will be referred to as “monthly”, meaning an owner can use an owned CTR once during a “month” or time period, and each CTR renews itself for the next “monthly” time period. Note also that, the physical cargo hold of a mode of transportation will not be broken into physical partitions by CTR. Rather, the CTR is a right owned by a particular club member to that much space, per time period, in a transport that travels along the club's route.

Taking into consideration the maximum cargo capacity in kilograms or volume and the places of operation, in one preferred embodiment, the organizers of the club mathematically divides the total available into equal parts, which are the actual CTRs. To elaborate using the example of FIG. 1, if the total cargo space available to the club in the cargo hold of an airplane is 72,800 Kilos, and it is determined by the organizers that each CTR is 500 kilos, the available cargo to the club having the route from Miami to Bogota would be 145 salable CTRs per trip. If, for example, it was decided by the organizers of the club having the route from Bogota to Miami, that the needs of that club required a CTR to be only 100 Kilos, then that club would have 728 salable CTRs per trip, using the same plane. If a plane of that size were chartered by the organizers of the club to fly from Miami to Bogota 15 days a month, then there would be 2,175 monthly CTRs available to be sold for the club. Note that adding more planes and/or more days for that route could increase the number of monthly CTRs available to the club. Alternately, a new club can be formed, if necessary, to sell the additional CTRs made available along that route.

In one preferred embodiment of the present invention, once the organizers of a club pick the route, secure the mode of transportation, and break the transportation option into salable CTRs, the organizers of the club would use means to locate in their database, or by other methods, the persons or corporations (cargo agencies, producers, custom shops, etc) that work that route. The interested persons could be invited, either directly or through publicity, to attend a presentation of the club, made by the organizers. This will be done through carefully planned events with the intention to show the advantages of the club to the potential members.

In one particular embodiment of the invention, all partners, owners, founders and/or administrators of the club will have the right to keep for themselves, any and all CTRs that have been designated as their own. Such CTRs can then be used by each partner, owner, founder and/or administrator, at its own convenience, to profit from and use for negotiating with, individuals and/or commercial entities, inside or outside of the Club, including those belonging to different clubs, or routes served by the system or to be implemented in the future. Such CTRs can be sold, changed or exchanged at the convenience of and to the benefit of such partners, owners, founders and/or administrators, to the extent that each partner, owner, founder and/or administrator fulfills the same requirements that apply to the regular members of the Club.

At the presentations, potential members will be offered the CTRs. Each CTR is offered to those who show an interest in becoming “members” of the club. Persons who show an interest in purchasing confirmed space on the route and who agree to the terms and conditions for retaining membership in the club, are offered membership. Each member of the Club purchases as many CTRs as he needs according to the amount of cargo he or she can use per month, either personally, or through sales to third parties. The amount of CTRs to be sold depends on the maximum capacity of the Aircraft or other mode of transportation, plus, if desired, 15% overload margin (to prevent trips with less than full cargo and to be able to accept urgent last minute cargo requests). Each CTR will have an equivalent kilogram, pound, etc., capacity to be defined by the Club and each member has the possibility to purchase as many as he needs (i.e., 1 CTR=500 kilos, in the present examples). The non exact amounts in kilograms, pounds, etc., are taken to the next hundred (ie. 48,445 kilos turn into 48,500 kilos).

The initial offering for CTRs in a club, like timeshare units, are sold once by the organizers, upfront. Aftermarket sale of CTRs purchased during the initial offering would be by the members who are in good standing and pursuant to the terms and conditions of membership. Note that CTRs owned by members who are in violation of the terms and conditions of the membership agreement (i.e., shipping forbidden items; in arrears of maintenance fees; etc.) can be foreclosed upon and resold by the organizers of the club.

However, under normal operation of the club, once a member purchases his CTRs, he or she can use them throughout the month, as desired. For example, an owner of 10 CTRs can divide those CTRs over 10 different days, can use them all in the same day, or can divide them in some other amount until all 10 are used in the month. These rights are the equivalent to shares in a Social Club, where the members become an active part of the Club and acquire benefits, rights and obligations.

The organizers of the club act as a management association, or turn the management of the club over to an actual management association. The management association is in charge of securing the mode of transportation, any necessary permits, and all other particular requirements. Each management association will operate only for the benefit of its members, never exceeding the maximum daily operational cargo, nor, in one preferred embodiment, being able to offer that quota to third parties outside the Club. Only the owners of the CTRs that are under utilized may offer space to third parties (in order to cover their rights). Thus, the risk of filling the cargo hold of the vehicle is borne by the members of the club, for their particular CTRs, and not by the club's organizers or the cargo transporter. Similarly, loss caused by cargo holds traveling empty is borne by the owners of the CTRs who have purchased the space, but have not used it.

As in any other type of club, all members have to pay a maintenance fee at the beginning of each “month”. In one preferred embodiment of the present invention, the maintenance fee is calculated according to the number of CTRs owned by each member. This fee is the main support of the Club and therefore it is very important that each member understands his responsibility on this matter. The maintenance fee is desirably chosen to constitute a real commitment from the members.

In order to avoid late payments or dangerous pending balances, those members who prefer can be financed by a Credit Institution, as long as they respond to all the requirements of the Bank. The club reserves the right to accept (or not accept) its members. A credit check and/or other means of careful study will be conducted to adjudge the suitability of each member, in order to prevent the future financial difficulties for the club.

Additionally, in order to alleviate the risks of non-payment of monthly fees by the members, the club may require each member to form an arrangement with a financial institution, wherein, if payment is not received by the club within a predetermined time period after a payment is due, the financial institution automatically makes the payment on behalf of the delinquent member (i.e., the club makes a direct draw of payment from the financial institution). Alternately, the arrangement can be made that all payments by the member (and not just “late” payments) are made directly to the club, by an automatic payment from the financial institution. It is then the responsibility of the financial institution, and not the club, to collect against the member. Such an arrangement can be established, as well as updated, using the club reservation system to which the member already has access.

Once each member purchases a desired number of CTRs and, contractually binds himself to the rules and conditions of the membership agreement, a member in good standing will have at least one or more of the following benefits, among others:
Important increase of the members profits.
There is only a pre-established number of members, exactly related to the monthly capacity of the aircraft.
Great reductions in the transportation costs.
Stability in the long term expenses, as the member can plan for his business.
No changes in the tariffs for seasonal peaks (Mother's Day, Valentine's, Christmas, etc). The club will maintain relatively the same (i.e., fixed) prices, throughout the year. Price changes will only respond to force majeure and they will be to the advantage of the members (fuel or oil price fluctuations, new contracts, etc). Further, in one embodiment of the preferred invention, each increase in the tariffs will be explained to the members, in paper or via electronic means, detailing how fluctuations effect the cost of shipping, per pound or kilo.
Performance, confidence, trust and security in the handling of cargo, all of which receives first class treatment.
Monthly financing (if needed) for easy payments to the club, with low interests, help to the club member and protection for the club.
If desired, constant communication with the club members and/or affiliates can be maintained, as often as daily, providing advice, recommendations, and information on electronic reservations and payments.
Available time to find new customers.
Receipt and delivery of merchandise in places implemented by the club.
Excellent and respectful treatment as exclusive member of the club.
Constant information about the air cargo business (internet, workshops, etc)
In one embodiment of the invention, if a member does not complete its quota in a given month, the remaining space can be rolled over, and the member can register on a waiting list to use the rolled-over units in a subsequent month. The member will be able to use it whenever it wants, depending on space availability (i.e., empty space can be utilized by the club to the members advantage). As such, in the instant embodiment, there would be no loss to the member.
A member will be able to offer any unused space to the other members, through the club, or to third parties. In one embodiment of the invention, in the event that there is another member of the club desirous to use the unused units of another member, negotiation for the transaction is conducted between the members, and not through the club.
If the affiliate needs extra space beyond his own quota, his extra merchandise may be transported, subject at an extra charge (i.e., one that is, preferably, very low compared to market levels and subject to space availability).
All available quota space may be offered by the affiliate to persons or entities inside or outside the club.
The membership to the club is a negotiable asset that may be resold by the member (pending on the club's approval of any new member).
The club (for example, in Colombia) can be used to network with other, affiliated clubs (for example, in China). Members can become acquainted with members of other clubs, in other countries, widening their international range in order to offer their products and services in more places.
Individual members will no longer be required to negotiate individually and accept bids from cargo transporters for shipments.
The company will provide strict respect in the delivery and pick up of the cargo. Delays in transportation are only caused by problems different from the clubs responsibilities (maintenance, weather, etc).
Taking into consideration the great influence and bargaining power that the company will have in the transportation world, the organizers, founders, etc or the company itself, will have the power to negotiate partial or total cargo quotas in pounds, kilograms, units, etc., with any other transportation agency or use its own means of transportation, under different conditions (purchase, lease, charter etc) for as many destinations as needed, and offer the negotiated destinations to the Club Members at special rates as another service of the Club, hence widening the range of services to the affiliates and increasing the number of destinations to any place in the world. The negotiated units, kilos or pounds are transformed into Club CTR, CTU, units, or packs, subject to members' obligations. This is an additional service that will enhance the benefits of Members, providing added value for their customers by offering them, as needed, an increasingly viable, fast, effective and reliable service, without destination limits.

Obligations of the club members could include at least one, and possibly all, of the following:
Purchase of the necessary rights at the events organized.
Give its cargo to the club, through a solemn and legal commitment, according to its purchased number of CTRs (based on its historical capacity of kilos, pounds, etc.,/month).
Pay the maintenance fee to the club within a determined time period, for example, as soon as five days prior to the first day of the month, or as late as days after the first of each month, or some other period, as desired. The club may require a deposit, such as two months of maintenance fees (to be held as bond for each member), to maintain the financial stability of the club, and to permit the club to fulfill its obligations in a timely fashion.
Make reservations with good time in advance. The club will enforce the premise “first reserved, first shipped”.
No shipping of drugs, weapons, money or substances restricted from normal shipping. Each member is fully responsible for the contents of its cargo. If desired, the club may require the member to fill out a form taking responsibility for the contents of his cargo.
Withdrawal of reservations, with enough time in advance so that it can be used by other members.
Other obligations to be determined by the club.
   Use of a Member's CTRs

Among the actions to be taken by the club member is the reservation of his shipping quota for the days he wants, directly or electronically with due advance. The Club will accept all reservations (as in any Social Club for a restaurant reservation, for example) under the premise of first reserved, first served. Timely reservations made by member's will be strictly respected. The club member has the right to receive cargo from third parties at a convenient rate, becoming the manager of its own quota, since his transportation needs are already fully covered. The price difference between the price charged by the Club and the price that the member charges the Third Party belongs to the club member. The Club does not interfere in this type of negotiations. The Club will maintain a close relationship with all members and will assist them when necessary. For instance, if a member cannot fill his quota by the end of the month, instead of loosing his monthly investment he will transfer (rollover) his remaining quota to the following month, under certain pre-established conditions and subject to space availability.

In order to avoid such events, the Club will maintain constant communication with and between the members, so those who have the most cargo will profit from the cargo deficit of those who have the least. Such negotiations (i.e., cost) will be between the members only and the Club will not participate in any way whatsoever. Club members will be able to negotiate with members of different air, sea or ground clubs (i.e., clubs covering other cities or countries and/or other clubs in the same system) that connect other destinations, so that their products may reach places outside the destinations of their own Club. Any member can leave the Club whenever he wants, notifying the Club in advance (for example, two months in advance). In one particular embodiment of the invention, payment for the two months notice period will be taken from the two months bond money, paid by the member upon joining the Club. A club member's membership is a negotiable asset that can be sold or transferred to another person or corporation (subject to the approval of the Club). If the club member does not pay his monthly fee the Club may choose to discontinue his membership and he will lose all membership rights. A forfeited member's CTRs will return to the Club and will be offered to other persons or entities inside or outside the Club, at the Club's own discretion.

Each type of transportation is a Club, and each Club will have the number of members according to the transportation capacity it has.

The same type of transportation, time permitting, may be used by another Club, in the same country or city, or in different locations, as long as their operation does not interfere with each other.

According to the number of people interested in a route, the necessary number of clubs will be opened to respond to the demand, independently of the country where it is required, always considering each club as an individual unit with its own dynamic. All means of transportation and infrastructure will be established according to the needs in each case.

One illustrative scenario follows:

Air Cargo Club. ACC COLOMBIA. (Route 1- and -2.).

Referring now to FIG. 1, there is shown a schematic of a reservation system for an airplane type DC-10-30. The particular airplane has a maximum cargo capacity allocated to the club of 73,000 kilos, plus 15%, for a total of approximately 79,000 kilos. The club would be created with members interested in route 1 (Miami-Bogota) and a second club would include members interested in route 2 (Bogota-Miami), the two routes making for a roundtrip.

In the example of FIG. 1, dividing the available space equally so that one (1) CTR=500 kilos, the number of CTRs offered daily for route 1 (Miami-Bogota) would be 79,000 kilos divided into 500 kilos=158 CTR per day. Similarly, the number of CTRs offered daily for route 2 (Bogota-Miami) would be 79,000 kilos divided into 500 kilos=158 CTR per day. If 158 CTRs were available per day, and the each route was traveled 26 times a month (more or less), the clubs for each of routes 1 and 2 would have 4,108 available CTRs/month.

Payment for each of the 4,108 available CTRs per route would be collected by the club, as follows:
1. Initial purchase price payment for the right to be in the Club, and for one or more CTRs by each member, purchased based on the historic capacity or convenience of the club member.
2. Initial deposit of maintenance fees for two months, determined by the corresponding number of CTRs purchased.
3. Within a predetermined period, i.e., the first five days of each month, payment of the maintenance fees for the month, based on the number of CTRs owned by the member. This payment is repeated each month.

Monies collected by the club may be held in a trust account, from which monies can be drawn to pay the expenses of the club, include the chartering of transportation, permits, maintenance and other fees.

The club will not use or sell the CTRs offered until it reaches a pre-established breaking point, which will allow the viability of the operation. For example, if less than a certain percentage of CTRs for a route are purchased during the initial offering, it is determined that there is not enough interest in the route and the club is disbanded prior to consummation of the final sale of the spoken for CTRs and the money held in trust is returned to the members.

This would be a basic scheme of the way the club would operate according to each particular type of transportation, cargo capacity and routes to cover. A member can belong to as many Clubs as he deems necessary.

### PRACTICAL EXAMPLE

A particular club is opened for shipping routes from Miami to Bogota. Mrs. Violet, an individual shipper using that route, typically ships 50,000 kilograms, pounds, etc., of different products per month. Mrs. Violet joins the club and purchases enough CTRs to cover her transportation needs. In the example where each CTR is 500 kilos, Mrs. Violet would need to purchase from the club, upfront, 100 monthly CTRs to cover her monthly shipping needs (100 CTRs×500 kilos=50,000 kilos per month). The remaining CTRs available per month along the route are sold to other interested individuals, who join the club for this transport route, until the number of monthly CTRs available are sold. The purchase of monthly CTRs occurs once. Those monthly CTRs purchased by a member become the “right” and property of the owner.

After purchasing the 100 CTRs from the club, Mrs. Violet is permitted to allocate her 100 CTRs throughout each month. For example, Mrs. Violet may make reservations for her 100 CTRs, distributed throughout the month, shipping product on different days until she reaches her quota; or Mrs. Violet may use her whole 100 CTR quota in a single shipment on a particular day. Mrs. Violet only has to make her timely reservations according to her business schedule. In one particular preferred embodiment of the invention, the reservation system is opened for each month on a particular day or date, and reservations for the month are accepted on a first come, first serve basis. All members of the particular club follow the same pattern given in the above example, to both purchase and reserve CTRs.

The Cargo Reservation System

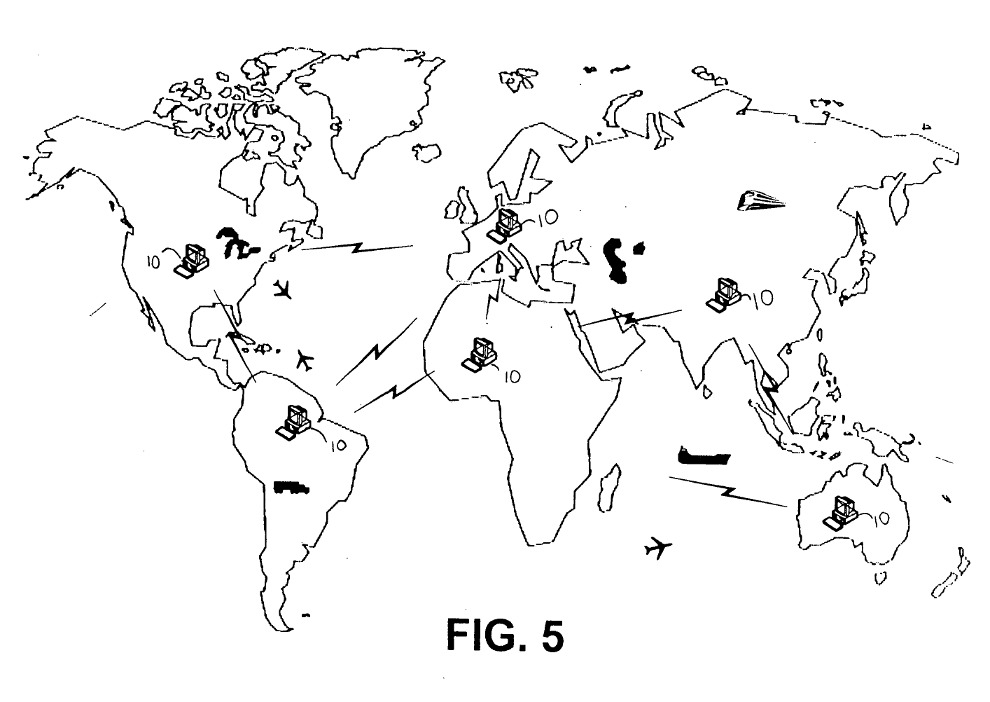

Referring now to FIG. 5, there is shown one particular embodiment of the cargo reservation system of the present invention, including a world-wide computer network for arranging the transportation of cargo. More particularly, the cargo reservation system of the present invention can reside on servers and/or workstations 10 maintained by each particular club, in each location, world-wide. The computers 10 can be connected to a communication network, such as the internet, to permit members and/or other clubs, interact with each particular clubs reservation system. Alternately, each reservation system can have dedicated lines, which members can access via the telephone network. Each computer 10 can maintain the reservation system for a particular club. Note that, although only a limited number of computers 10 are shown in the example of FIG. 5, an unlimited number of computers can be connected to the communications network, and/or an unlimited number of clubs, each having at least one computer 10, can operate.

As stated above, the information stored on computers 10 can be accessed by members of each club and/or other cargo reservation systems, in order to make cargo reservations in accordance with the rules and membership rights permitted by each club.

Referring now more particularly to FIGS. 1-4, there are shown representative computer screens that can be used by members of particular cargo reservation systems to reserve space, in accordance with their monthly allotments. Note that members may be entitled to use their CTR allocations over more than one means of transportation, as defined by their club membership.

Referring now to FIG. 1, there is shown a representative computer screen view 100 of an air cargo reservation system, that can be used by a member of an air cargo reservation club, to reserve space on an airplane for the transportation of cargo. The reservation screen view provides a member with both information and the ability to make a reservation. The cargo reservation screen view can be generated by proprietary software operating on the member's computer, which is provided as part of the membership package. Alternately, and more preferably, the reservation screen view is accessed remotely by the member, using a browser program, over a communications network (i.e., such as the internet). In such a system, the member would be required to enter the member's ID and password, prior to being granted access to the screen view shown in FIG. 1.

Once the member has logged into the system, the user can select a desired route and travel date, using the boxes 110 and 120, respectively. The member can be assisted in the selection of a route by on-screen drop down menus, accessed by the arrow 112, which provide the user with a choice of possible routes. Similarly, once the route has been selected in the window 110, a drop-down menu or calendar picker may be provided to assist the user in selecting possible travel dates. Note that, if the present club provides more than one transportation type (i.e., airplane, ship, train, truck, etc.), then the user will additionally select the type of transportation desired. Additionally, if the member belongs to a club wherein the transportation route is fixed between two locations by the club charter (i.e., from a first location to a second location, only), then the drop down arrow 112 will be omitted, and the window 110 will display the route title, without permitting a different route to be selected.

Once date has been selected (and, if permitted by the club charter, a travel route), information about that route and date are displayed. For example, if only one departure time is available, that information is displayed in a departure time field 130 of the screen view 100. If additional departure times are provided for that route on that date, a drop-down menu can be provided to assist the user in selecting the desired departure time.

Once the date and departure time are selected, the member will be shown the availability for that flight (or truck or train or ship, depending on the mode of transportation available to the member). For example, a graphical representation 140 of the cargo transport availability can be shown on the view screen 100. Additionally, a numerical breakdown 150 of the cargo transport availability can also be provided. For example, the number of CTR units confirmed, reserved and available, can be numerically represented in the informational area 150, as well as graphically shown in the graphical representation 140. Additionally, general information can be provided to the member, via the screen view 100.

For example, the total capacity of the vessel (in pounds, kilos and CTRs, if desired) can be shown in the area 160.

More general warnings, such as policies on confirmation of reserved CTRs, or general reminders (i.e., “please deliver cargo 24 hours prior to departure”) can additionally be provided, as is shown in areas 162 and 164 of the screen view 100. If the member desires more information about the club's confirmation policy, the member can click on the “click for details” button 163, to bring up a window with more information on the clubs reservation policies. Similarly, for club policies in general, the member can click with the mouse pointer 170 on the “here” link 165.

Other interactive information can additionally be accessed by the member, using the screen view 100. For example, as stated herein, the club can help facilitate the purchase and/or exchange of monthly units between members. Information of additional units being listed for sale by a member can be provided to a member, for example, by clicking the mouse pointer 170 on the “click for details” soft button associated with the “Additional CTR Availability” message 166. Additionally, clicking the button 166 button could also present the member with the option to trade and/or sell surplus CTRs that the member will not use that month.

Further, as stated herein, the monthly fees for transport are subject to minor fluctuations for variable costs, such as fuel price, rack fee, etc. An informational window 167 can be provided to apprise the member of current prices which effect the member's monthly fees. For example, the window 167 can apprise the member of the current (i.e., daily) fuel price, rack fee, or of other costs that will effect the member's monthly service fees. Clicking the “click for details” soft button 168 can provide the user with more information on these additional costs, including a break-down of monthly charges.

Additionally, the member can access customer support by clicking the “For Customer Service, Click Here” link 169, at the bottom of the view screen. Clicking on the link 169 can send the member to another window or screen that provides additional customer support help and/or information and/or contact information. Alternately, or additionally, clicking the link 169 can open a “live chat” window with a customer service representative.

Using the computer input devices, such as a keyboard and/or mouse, a member can input their reservation into the clubs computer system, from the screen view 100. For example, by selecting an area with the mouse pointer 170, the member can make a reservation, using their computer keyboard and/or mouse. For example, the member can enter the number of packs or CTRs being reserved for a particular flight, change the date to view other screens, or confirm by entering their membership code in the input box 180. Hitting the button 190 will enter the reservation into the clubs system and databases.

Note that a greater or lesser amount of information could be provided to the member on the screen view 100. For example, information could be provided regarding the members total monthly allotment of CTRs, including how many have already been used and/or reserved. Additionally, previously reserved CTR cargo space could be edited, confirmed and/or cancelled, via other screens of the cargo reservation system.

Referring now to FIGS. 2-4, it can be seen that the cargo reservation systems of those embodiments provide substantially similar interaction between the member and the club reservation system, via the cargo reservation screens 100′.

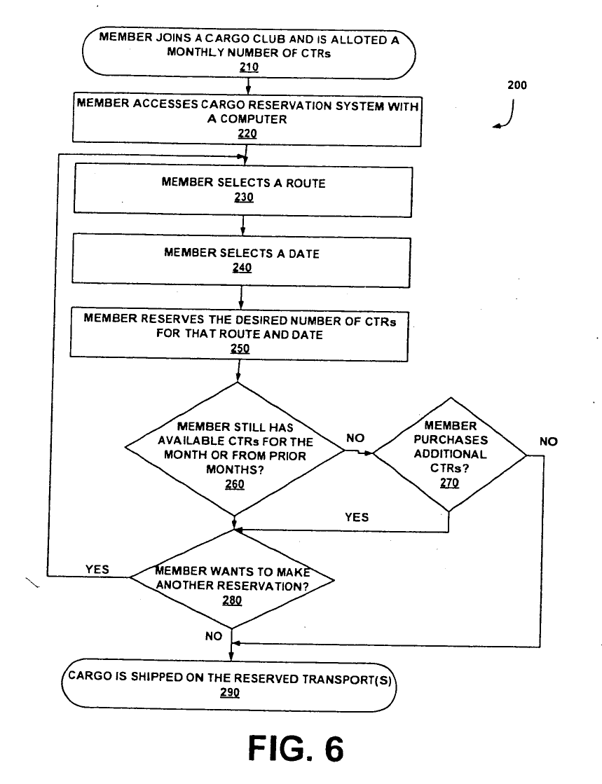

Referring more particularly to FIG. 6, there is shown a flow diagram of one particular embodiment of a method 200 of using a cargo reservation system of the present invention, for example, via the screen views of 100, 100′. More particularly, an individual, partnership, organization or other entity joins a cargo club and receives an allocation of CTRs or packs, provided on a monthly basis, or on the basis of some other period of time (i.e., yearly, daily, etc.). Step 210. Note that the individual or entity (i.e., collectively “member”) can join more than one cargo club and/or that the particular joined cargo club can provide transport on more than one type of vessel (i.e., ship, airplane, train, truck, bus, etc.).

When the member wishes to reserve cargo space on a vessel that has been secured by a cargo club to which the member belongs, the member accesses the cargo reservation system with a computer (i.e., for example, via the screen views 100, 100′). Step 220. Once in communication with the cargo club's reservation system, the member selects a route and a date of transport. Steps 230 and 240. Note that, if the present club provides more than one transportation type (i.e., airplane, ship, train, truck, etc.), then the user will additionally select the type of transportation desired. Additionally, if the member belongs to a club wherein the transportation route is fixed by the club charter, then step 230 will be omitted.

Using the reservation system the user reserves the desired number of CTRs on that route and date, from those available. Step 250. As noted previously, in one embodiment, reservations are taken on a first come, first served, basis. The reservation of the user is stored in the cargo club computer system. Note that the cargo club computer system maintains records identifying the members of the club, and keeps track of the number of units allocated to each member for the month or other predefined time period. During the predefined time period, the numerical quantity of cargo units reserved by a user are subtracted from the total number of cargo units available to the user in the predefined time period (i.e., month). The cargo club computer system additionally keeps track of the current number of cargo units available to the member in the predefined time period. Note that, as part of the club computer system, at the beginning of each new time period (i.e., for example, each new month), the total number of cargo transport rights available to a user returns to, at least, their allotted monthly number of cargo transport rights. Optionally, the number of unused cargo transport rights from previous months can be added to the total number of CTRs allocated to a user in a predefined time period. For example, a user that owns 10 CTRs per month, and who rolls 2 unused CTRs over from a previous month, may have a total of 12 CTRs automatically allocated to them in the new month.

If the member has reserved all of its monthly allotment of CTRs, (and, optionally, any CTRs carried over from previous months, as described herein), the user can choose to purchase additional CTRs. Steps 260 and 270. As stated herein, CTRs can be sold by other members and/or by the cargo club, as available. If the member still has CTRs available from their monthly allotment, or from a previous month (as described herein), the user may choose to make other reservations. Steps 260 and 280.

Once CTRs have been reserved, cargo can be shipped on the reserved transport(s). Step 290. It should be noted, however, that the CTRs may be used by someone other than the reserving member. For example, the reserving member may use the CTRs to ship cargo, or may resell or sublet the CTRs, as discussed elsewhere herein.

Alternately, if desired, the reservation system of the present invention can be enacted on a telephone system which can be accessed by members to reserve CTRs, using a interactive voice menus, and the keys of a touch-tone telephone.

Presentation And Sale Of The CTRs

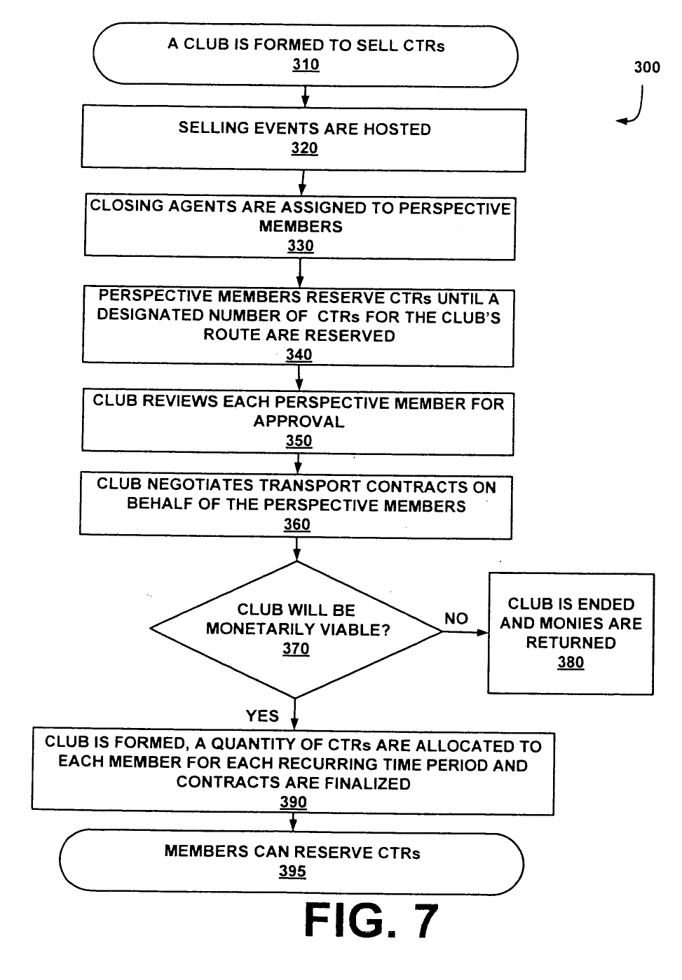

Referring now to FIG. 7, there is shown a flow diagram of one particular embodiment of a method 300 for establishing a club. The CTRs will be presented and sold following basic schemes adopted and modified by the clubs, under their charters. Step 310.

The Cargo Transportation Rights, CTRs, are sold during social/commercial events specially organized to offer the product to those who have an interest in the transportation business, either as service providers, couriers, carriers or cargo consolidators, etc. Step 320. Each person who receives the invitation to the event is carefully selected. Club organizers shall organize as many events as necessary until the total number of CTRs offered according to the capacity of that particular Club are sold.

If desired, the club organizers can engage a professional presenter to show the whole project to the potential club members. During each presentation information about the benefits and obligations of club membership will be given to the perspective members. For example, a video may be shown explaining the whole business operation, including the advantages, benefits, savings, as well as the problems that may appear and the obligations of each member. At such a time that a guest decides to become a member of that particular club, a “Closing Agent” will, optionally be assigned to the guest, to enroll the guest in the club and provisionally contract for the guests desired number of CTRs. Step 330. The member that is not sure about the actual capacity he needs can reserve his quota, for a set period of time, by executing an agreement that backs up his commitment, so he does not take CTRs that may be purchased by someone else. This process will be repeated until the total number of CTRs offered by the club are sold. Step 340.

The club reserves his right to carefully study each member and may choose only those who show the appropriate membership attitude and enough professionalism to participate and respond for all his obligations. Step 350. All member monies received will be placed in a trust account, which will keep it until it reaches a breaking point that allows the opening of the operation. Backed by the funds held in trust, the club will be able to start preliminary negotiations and form preliminary, possibly contingent agreements and take all the necessary steps to be ready to commence operation of the club, as soon as the breaking point (i.e., the point at which a number of CTRs are sold which make the operation of the club viable) is reached. Step 360. In the rare case that this breaking point is not reached, all monies held in trust will be returned to the club members with all additional interest that may have been earned according to the bank rates, avoiding any possible loss for the prospective club member. Steps 370 and 380. Once the breaking point is reached, and the club is formed, the monies held in trust will be transferred to an operating account, with the exception of any security deposits of the members, which remain in trust. Steps 370 and 390.

Once the club has officially formed (i.e., the breaking point has been reached and the CTRs necessary for viability have been sold), the club will send to each selected member an acceptance and welcoming letter, explaining in detail the steps to follow. Upon receipt, the club member must close the deal by executing the necessary contracts and receive all documents that credit him as an active club member. Then, each member will be apportioned a quantity of CTRs for use in each recurring time period Step 390. For example, if the subscription purchased by the members is on a monthly basis (i.e., the predetermined time period being one month), then each month, the member will automatically have available to them at least the subscribed to number of CTRs. In the preferred embodiment, the member is entitled to the same number of CTRs every month. However, in one embodiment, the member may additionally be credited with an additional quantity of CTRS, based on the quantity of unused CTRs in a previous month, or in previous months. Note, as described herein, although a quantity of CTRs are assigned to a member for each current predetermined time period (i.e., a month), in the current preferred embodiment, the actual dates of transport for the use of those CTRs is not assigned to a member until the member affirmatively reserves specific dates of transport. Step 395.

Optionally, a Financial Credit. Entity may be formed to assist the Club members. Such a Financial Credit Entity may be present at club sales events. This Financial Institution may finance the members in their obligations toward the club, if needed. Note that the obligations accrue to each member, and not to the club, as a whole.

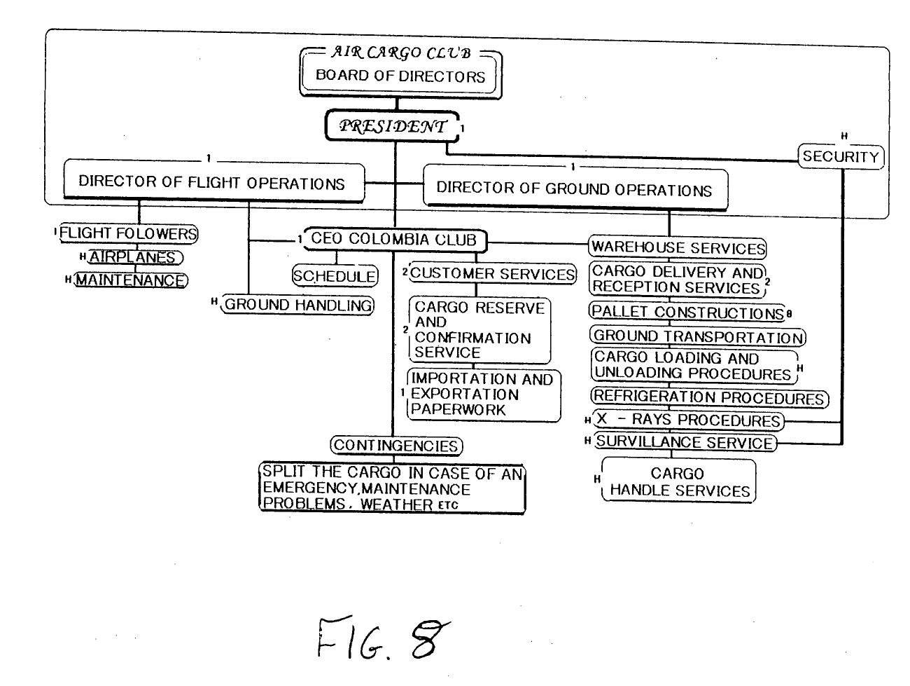

The management association/organizers of the club negotiate for the cargo transport space for the operation, either through direct leasing and personal operation, transportation services or other, takes care of the legalization of all documents according to the countries involved, closes any additional deals (already pre-established) for the operation of the Club. Step 390. FIG. 8 is an organizational chart for one particular embodiment of an organization that can be used with a cargo reservation system of the present invention, in order to facilitate services for the membership of a particular cargo club.

Importantly, the club saves the members time and money because individual members will no longer be required to negotiate individually and accept bids from cargo transporters for shipments. Additionally, by having set fees for the transport (only subject to minor fluctuations for fuel, etc.), which are a set monthly expense known to the members well in advance, members can more readily plan the long term cash flow of their businesses.

If desired, in one particular embodiment of the invention, in order to encourage the clients or members to join the Club and, once in the club, to participate to the fullest extent, the partners, owners, founders and/or administrators of the Club may provide members and clients with prizes and/or bonuses. For example, since the system works on an advanced payment basis for transportation rights in units, pounds, kilograms, etc., the clients or members will profit from the low rates offered by the system. However, if desired, the clients or members can also be rewarded by being given freight quotas at very special rates, or even at no cost. If desired, members may be rewarded by receiving reward points for making purchases using a Club associated or approved credit card, which points can be redeemed for value in the Club. For example, accruing a certain number of “reward points” on a Club affiliated credit card could entitle a member to bonus miles or kilometers on an airline having an arrangement with the Club. The aim of such bonuses or rewards in the present embodiment is to motivate clients or members to get actively involved with the Club, sharing their observations using its services to their full extent and encouraging new clients to join the Club, thus helping the Club or Clubs grow to attain members in all different world markets.

The club can maintain contact with its members through all means, including existing electronic means. A website, can be set up to accept reservations of the members electronically. A reservation availability screen for the website may look like that shown in FIGS. 1-4, or may be otherwise designed. Additionally, the club member may make a reservation from the screen shown in FIGS. 1-4, by entering the number of CTRs, date and members code in the “make your reservation” box, shown in the figures, and hitting the okay button next to confirm.

The club members make their reservations, conscientiously, bearing in mind that the reservations are allocated on a first come first served basis, per month. As such, once a shipment is filled by members exercising their CTRs, other shipment dates will have to be chosen by members who reserved late. Members who, through their inability to select or reserve dates, do not use their monthly CTRs may be able to use them in the following month, on a last minute, space available basis. In other words, if there is space available in a shipment that is about to leave, and no member has reserved this space with a current, monthly CTR, the club may choose to accommodate members who did not use their CTRs in the previous month, by shipping the cargo in the prepaid space.

Additionally, once they have covered their transportation needs, the club members can concentrate on selling to their advantage any available space in their quota. Urgent deliveries will be considered on particular bases, based on the space available premise. All members can check electronically how the cargo hold is getting filled, which allows them choose the best days to ship their products, using an availability screen, such as is shown in FIGS. 1-4, to permit a member to choose space in its respective club for a particular day. Using the screens of FIGS. 1-4, the member can see how many CTRs are confirmed, reserved or available for a particular date. Based on this information, a member may judge availability and place his or her own reservations.

All members have to arrange delivery and pick up of their merchandise at the club. The transport vehicle has an established itinerary that will only be modified by force majeure (weather, maintenance, etc). As an added benefit, the club will keep the members informed via e-mail about all events in the cargo business, tips and updates that may be profitable for them. It will also connect those members who need more space and those who have extra space and need to fill their quota. (See membership benefits). All dangerous articles will be treated in a special way by qualified personnel at an extra fee. If there is no merchandise to be transported, for any reason whatsoever, the club will follow the itinerary previously established by the club, even if a vehicle travels empty. This event will not affect the club's economy, since all members have paid their dues in advance. The club's charter may permit the cargo of members to fly on space available flights, subject to the rules of the club.

The above disclosure, for purposes of explanation, refers only to one club. However, this is not meant to be limiting. It is a premise of the instant invention that, if desired, a plurality of clubs will be formed covering different routes and/or modes of transportation. Similarly, a single club can be formed that provides access to a plurality of routes and/or a plurality of modes of transportation. Additional clubs may also be formed along the same routes, as clubs fill-up (closing membership to new members), where the need exists. Clubs will also be created according to the countries that need to be serviced and the affiliates that want to participate. There will be as many clubs as are both necessary and financially viable.

As such, the instant invention unites groups of interested parties under strict parameters, in this case a club, in order to join efforts and be able to reach a bargaining capacity in “cargo kilograms”, “cargo pounds”, “cargo units”, etc. Such advantage can be strong enough to obtain excellent discounts for the lease or purchase of the transportation means or services in the carriers and all other related services for the shipping of the merchandise.

Further, individual members will no longer be required to negotiate individually and waste time accepting bids for the job from multiple cargo transporters for shipments. The system and method of the present invention eliminates all intermediaries and eradicates unnecessary expenses that increase the final costs of operation for individuals engaged in negotiating shipping for their businesses. With known costs, club members can better plan the cash flow of their business throughout the year.

I claim:

1. A system for reserving cargo transport space by the members of a club on a recurring periodic basis, comprising:
a reservation system for reserving units of cargo transport space, said reservation system including information of each member, said information including a numerical quantity representative of the current units of cargo transport space available to each members during a pre-defined time period;
an access terminal for remotely accessing said reservation system, by a member, for reserving at least one unit of cargo transport space on behalf of that member;
said reservation system storing a reservation for at least one unit of cargo transport space on behalf of the member in a particular predefined time period;
in response to said storing, said reservation system reducing the numerical quantity representative of the current number of units available to the member for the particular predefined time period, by the number of units of cargo transport space reserved; and
said reservation system automatically crediting each member with a set number of units of cargo transport units at the beginning of a new predefined time period.

2. The system of claim 1, wherein each member starts each new predefined time period only with the set number of units.

3. The system of claim 1, wherein said set number of units is added to a numerical quantity representative of the units remaining at the end of a previous predefined time period, the sum representing the total number of units allocated to an individual for the new predefined time period.

4. A method for allocating cargo transport space to members of a cargo club, comprising:
providing a plurality of units of cargo transport space available during a predetermined time period on a recurring periodic basis;
assigning a portion of the plurality of units to each of the members for use during the predefined time period;
reserving at least one unit of cargo transport space on behalf of a member in a particular predefined time period;
reducing the total number of units available to the member, for the particular predefined time period, by the number of units reserved on behalf of the member; and
automatically crediting each member with a numerical quantity representative of the assigned portion of the plurality of units at the beginning of a new predefined time period.

5. The system of claim 4, wherein each member starts each new predefined time period only with the assigned portion of the plurality of units.

6. The system of claim 4, wherein said numerical quantity representative of the assigned portion of the plurality of units is added to a numerical quantity representative of the units remaining at the end of a previous predefined time period, and the sum represents the total number of units allocated to an individual for the new predefined time period.

7. The method of claim 4, wherein said member can only make reservations for cargo transport along a particular route.

8. The method of claim 7, wherein the member can only make reservations for a particular transportation method along said particular route.

9. The method of claim 4, wherein each member can trade or sell at least a portion of their units to another member for use on behalf of the another member in a particular predetermined time period.

10. A method for providing cargo transport space to members of a group, comprising the steps of:
recruiting the members for shipping cargo;
arranging for available bulk cargo transport, over a plurality of predetermined time periods;
allocating the cargo transport space available for each predetermined time period, as a plurality of cargo units; and
apportioning to each member of the group, a portion of said plurality of cargo units, each member being entitled to the use of the portion during each of the plurality of predetermined time periods.

11. The method of claim 10, wherein each member is additionally entitled to the use, in a present predetermined time period, of a numerical quantity of cargo units that the member did not use in a previous predetermined time period.

12. The method of claim 10, wherein bulk cargo transport is arranged for in said arranging step only along a particular cargo transportation route

13. The method of claim 12, wherein the particular cargo transportation route is between a first location and a second location.

14. The method of claim 12, wherein the particular cargo transportation route is only from a first location to a second location.

15. The method of claim 14, wherein a different group retains the rights to transport cargo from said second location to said first location.

15. The method of claim 10, wherein, during the apportioning step, the cargo units apportioned to each member are not assigned for specific dates of transport.

17. The method of claim 16, wherein each member reserves specific dates of transport for at least a portion of the apportioned portion, during a specific predetermined time period.

18. The method of claim 17, wherein the member uses a computer reservation system to reserve the specific dates of transport.

19. The method of claim 10, wherein the group is recruited at a plurality of special recruiting events.

20. The method of claim 12, wherein a plurality of different groups are recruited, each group pertaining to a different predetermined cargo transportation route.

21. The method of claim 20, wherein said bulk cargo transport space is arranged on at least one of a plane, a ship, a train and a truck.

22. A method for reserving cargo transportation space by a member of a cargo club, wherein each member of the cargo club is allocated the use of a set quantity of units of cargo space on a recurring periodic basis, each of the set quantity of units not being limited to a particular transport date, the method comprising the steps of:
accessing a cargo reservation system including a database which includes information on the set quantity of units of cargo space allocated to the member in each predetermined time period and information on a quantity of units of cargo space not yet reserved on behalf of the member during a particular time period; and
reserving a quantity of units of cargo transportation space on a particular transport date for the benefit of the member, the quantity of units reserved being limited by information contained in the database.

23. The method of claim 22, wherein each member can trade or sell at least a portion of their quantity of units of cargo space not yet reserved to another member for use on behalf of the another member in during the particular predetermined time period.

24. The method of claim 22, wherein each member is additionally entitled to the use, in a present predetermined time period, of a numerical quantity of cargo units that the member did not use in at least one previous predetermined time period.

25. The method of claim 22, wherein the cargo transportation space for use by the member is only along a particular cargo transportation route.
